(19) United States
(12) Patent Application Publication
(10) Pub. No.: US 2022/0238095 A1
(43) Pub. Date: Jul. 28, 2022

(54) TEXT-TO-SPEECH DUBBING SYSTEM

(71) Applicant: CYBERON CORPORATION, New Taipei City (TW)

(72) Inventors: Yu-Chun LIU, New Taipei City (TW); Fang-Sheng TSAI, New Taipei City (TW)

(21) Appl. No.: 17/578,897

(22) Filed: Jan. 19, 2022

(30) Foreign Application Priority Data
Jan. 22, 2021 (TW) 110102530

(51) Int. Cl. G10L 13/08; G10L 13/02; G10L 15/16; G10L 15/02

(52) U.S. Cl. CPC G10L 13/08; G10L 13/02; G10L 2015/025; G10L 15/02; G10L 15/16

(57) ABSTRACT

A text-to-speech (TTS) dubbing system is provided, including: a speech input unit, configured to obtain speech information; an input unit, configured to obtain target text information and a parameter adjustment instruction; and a processing unit, including: an acoustic module, configured to obtain a speech feature vector and an acoustic parameter of the speech information; and a text phoneme analysis module, configured to analyze a phoneme sequence corresponding to the target text information according to the target text information; and an audio synthesis unit, configured to adjust the acoustic parameter of the speech information according to the parameter adjustment instruction, and combine speech information obtained after the acoustic parameter is adjusted with the target text information to form a synthesized audio.

### BACKGROUND

### Technical Field

The present invention relates to an algorithm for extracting speaker vectors from an audio file of an unknown speaker, an algorithm for obtaining, through separation, acoustic parameters and separating entangled acoustic parameters for quantification, and a text-to-speech (TTS) dubbing system in which acoustic parameters are manually controllable.

### Related Art

In a current TTS system, in a multi-speaker aspect, to enable a synthesized speech to be the same as that of an original speaker as much as possible, speech features of the speaker need to be extracted, such as timbre, rhythm, mood, and speaking speed. There are roughly two extraction methods. A first method is to encode, by using a speaker identification model whose long-term training has been completed, the speech features of the speaker into an algorithm of speech feature vectors to be directly used. A second method is to number the speakers, generate a speaking embedding lookup table after long-term training of a language model, find a corresponding speaker in the form of a lookup table and extract speech feature vectors of the speaker.

In the first method, it is emphasized that regardless of how similar timbres of the speakers are, the speaker identification model needs to have a capability of distinguishing between the speakers. Therefore, all the speech feature vectors obtained by using this method are classified into completely different speech feature vectors even if human ears cannot distinguish between different sounds, which is not conducive to usage of TTS. The reason is that, to synthesize a sound of a similar speaker, required speech feature vectors should also be similar. This also means that the speech feature vectors obtained by using this method do not completely include all features of the speaker.

In the second method, because the table of the trained model is fixed, the scalability of the model is very low, and only speeches of the speakers that already exist in the table can be synthesized. If a new speaker needs to be added, speech data of the new speaker needs to be collected, and the entire model is retrained. This is very time-consuming and hinders the development of a customized TTS model.

In addition, all the current customized TTS models are established based on neural networks. Due to the self-adaptability of the neural networks, in a case that an exact corresponding physical quantity is not provided in speech data, all obtained speech feature parameters are entangled. That is, it is impossible to individually make an adjustment for a specific feature (timbre, rhythm, mood, speaking speed, or the like). In addition, it is difficult to quantify the physical quantity corresponding to the specific feature, or there is a certain error in a quantization manner, resulting in difficulty in achieving a controllable customized TTS model system.

### SUMMARY

The present invention provides a TTS dubbing system, to reduce, by using a fixed TTS model, time and money costs of collecting speech data and training a model and improve the universality of the model.

The present invention provides a TTS dubbing system, including: a speech input unit, configured to obtain speech information; an input unit, configured to obtain target text information and a parameter adjustment instruction; and a processing unit, including: an acoustic module, configured to obtain a speech feature vector and an acoustic parameter of the speech information; and a text phoneme analysis module, configured to analyze a phoneme sequence corresponding to the target text information according to the target text information; and an audio synthesis unit, configured to adjust the acoustic parameter of the speech information according to the parameter adjustment instruction, and combine speech information obtained after the acoustic parameter is adjusted with the target text information to form a synthesized audio.

In an embodiment of the present invention, the processing unit further includes a speech feature acquisition module, a speech state analysis module, and a speech matching module.

In an embodiment of the present invention, the speech feature acquisition module converts a speech feature corresponding to the speech information into the speech feature vector according to the speech information.

In an embodiment of the present invention, the speech state analysis module is configured to obtain the acoustic parameter.

In an embodiment of the present invention, the audio synthesis unit imports a neural network model, and trains the neural network model according to the speech feature vector and the acoustic parameter, to establish a TTS model.

In an embodiment of the present invention, the audio synthesis unit inputs a target speech file of a speech database into the acoustic module, and obtains a target speech feature vector and a target acoustic parameter through forward propagation of the neural network model.

In an embodiment of the present invention, the audio synthesis unit forward propagates a predicted target audio file according to the target speech feature vector and the target acoustic parameter.

In an embodiment of the present invention, the processing unit calculates an error value between the predicted target audio file and the target speech file.

In an embodiment of the present invention, the neural network model backpropagates the error value according to the error value, and adjusts the audio synthesis unit and the acoustic module according to the error value.

The present invention provides a TTS dubbing system, including: a speech input unit, configured to obtain speech information; an input unit, configured to obtain target text information and a parameter adjustment instruction; and a processing unit, including: an acoustic module, configured to obtain a speech feature vector and an acoustic parameter of the speech information; and a text phoneme analysis module, configured to analyze a phoneme sequence corresponding to the target text information according to the target text information; and an audio synthesis unit, configured to import the parameter adjustment instruction into a TTS model to adjust the acoustic parameter of the speech information, and combine speech information obtained after the acoustic parameter is adjusted with the target text information to form a synthesized audio.

In the present invention, only a fixed TTS model needs to trained, and may be used in all situations provided that a small amount of speech data (1 to 10 sentences) is given to a specified speaker or speech feature vectors of a speaker and corresponding speech feature parameters are set autonomously, thereby greatly reducing time and money costs of collecting speech data and training the model and improving the universality of the model, and a manner in which the speaker performs cross-language conversion is also provided.

### BRIEF DESCRIPTION OF THE DRAWINGS

FIG. 1 is a schematic block diagram of elements in the present invention.

FIG. 2 is a schematic diagram of a training architecture of a TTS model in the present invention.

FIG. 3 is a flowchart of steps of an acoustic module in the present invention.

FIG. 4 is a flowchart of steps in an exemplary embodiment of a TTS dubbing system in the present invention.

### DETAILED DESCRIPTION

To make the features and advantages of the present invention more comprehensible, a detailed description is made below by using listed exemplary embodiments with reference to the accompanying drawings.

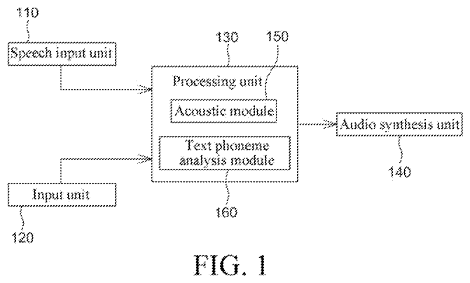

FIG. 1 is a schematic block diagram of elements in the present invention. In FIG. 1, a TTS dubbing system includes: a speech input unit 110, an input unit 120, a processing unit 130, and an audio synthesis unit 140.

The speech input unit 110 obtains speech information of a speaker by using an audio collection device. The input unit 120 may be a keyboard, a mouse, a writing pad, or various other devices capable of inputting text, and is mainly configured to obtain target text information and a parameter adjustment instruction in a final stage of audio synthesis.

The processing unit 130 includes at least an acoustic module 150 and a text phoneme analysis module 160. The acoustic module 150 further includes a speech feature acquisition module, a speech state analysis module, and a speech matching module. The acoustic module 150 obtains a speech feature vector and an acoustic parameter of the speech information. Further, the speech feature acquisition module mainly converts a speech feature corresponding to the speech information into the speech feature vector according to the speech information; the speech state analysis module is configured to obtain the acoustic parameter; and the text phoneme analysis module 160 is configured to analyze a phoneme sequence corresponding to the target text information according to the target text information.

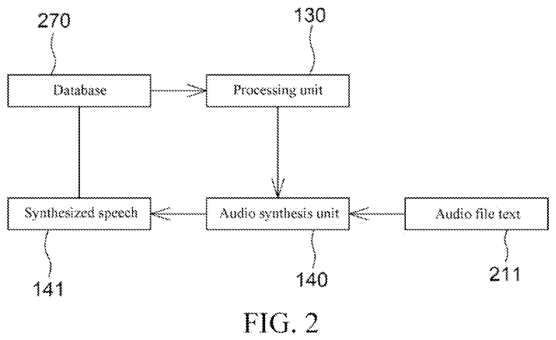

FIG. 2 is a schematic diagram of a training architecture of a TTS model in the present invention. The audio synthesis unit 140 imports a neural network model, and trains the neural network model according to the speech feature vector and the acoustic parameter, to establish a TTS model. During training of the neural network model, the audio synthesis unit 140 inputs a target speech file of a database 270 into the acoustic module 150, and obtains a target speech feature vector and a target acoustic parameter through forward propagation of the neural network model; the audio synthesis unit 140 forward propagates a synthesized speech 141 according to the target speech feature vector, the target acoustic parameter, and a corresponding audio file text 211, where the synthesized speech is a predicted target audio file; the processing unit 130 calculates an error value between the predicted target audio file and the target speech file; and the neural network model backpropagates the error value according to the error value, and adjusts the audio synthesis unit 140 and the acoustic module 150 according to the error value. Further, the neural network model adjusts various parameters according to the error value during training of the neural network model, so that the trained TTS model can minimize the error value. Therefore, after adjusting the acoustic parameter of the speech information according to the parameter adjustment instruction, the audio synthesis unit 140 combines speech information obtained after the acoustic parameter is adjusted with the target text information to form a synthesized audio.

After the training is completed, received speaker features and acoustic features of a speech synthesizer include an output feature of a speech feature extraction model; the output feature of the speech feature extraction model is finely adjusted as required; and the feature is customized as required.

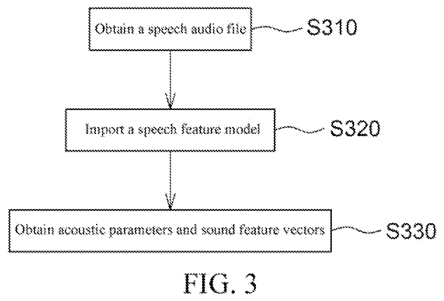

FIG. 3 is a flowchart of audio analysis steps of an acoustic module in the present invention.

Step S310: Obtain a speech audio file.

Step S320: Import a speech feature model.

Step S330: Obtain acoustic parameters and sound feature vectors.

In this embodiment, the acoustic module may alternatively perform sound feature acquisition in a manner of importing a neural network model, and train a deep neural network model according to acoustic parameters and sound feature vectors, to establish a speech feature model.

The acoustic module obtains training data, including a large quantity of speaker audio files; performs a machine learning program by using audio file information, to obtain, through training, a speech feature extraction model; and performs speech feature extraction for an input audio file by using the speech feature extraction model, to extract speaker features and acoustic features corresponding to the audio file. The speech feature extraction model includes convolution operations with a plurality of weights and an attention model, and the speaker audio files of the training data include one or more languages.

In this embodiment, the speaker audio file features are separable independent parameters. The speaker audio file features include, but not limited to, gender, timbre, high pitched degree, low pitched degree, degree of sweetness, degree of magnetism, degree of vigorousness, spectral envelope, average frequency, spectral centroid, spectral spread, spectral flatness, spectral rolloff, and spectral flux. Tone tuning parts include a lip, a tongue crown, a back of tongue, and a guttural sound. Tone tuning manners include manners of using double lips, lip teeth, tongue to lip, teeth, gingiva, back teeth, tongue rolling, an alveolo palatal, a hard palate, a soft palate, a uvula, a pharynx, an epiglottis, a glottis, and the like.

In this embodiment, the acoustic features are separable independent parameters. The acoustic features include, but not limited to, volume, pitch, speaking speed, duration, speed, interval, rhythm, degree of happiness, degree of being grieved, degree of being angry, degree of doubt, degree of joy, degree of anger, degree of sadness, degree of fear, degree of disgust, degree of surprise, and degree of envy.

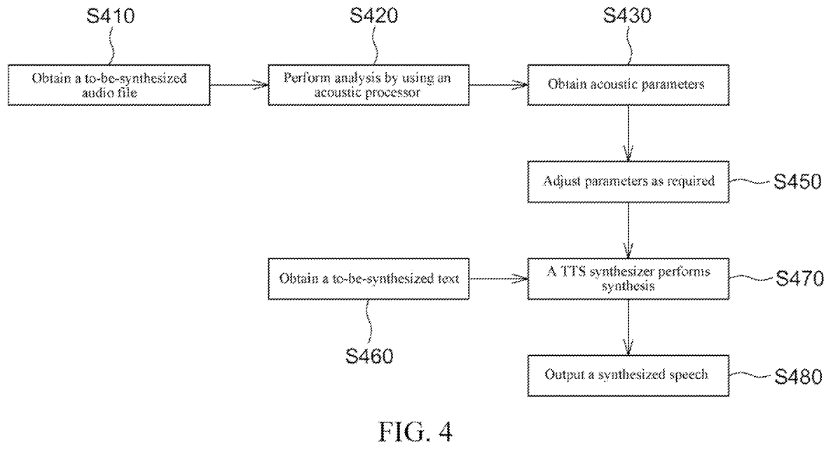

FIG. 4 is a flowchart of steps in an exemplary embodiment of a TTS dubbing system in the present invention. After the training of the model is completed, speech feature vectors and acoustic parameters may be obtained through an acoustic processor in need of only a single-sentence audio file. In this case, by selecting to use an acoustic state of the audio file or autonomously setting parameters, a sound of a speaker of the audio file may be synthesized into a sentence with any mood, speed, pitch, or the like, and the audio file does not necessarily belong to a known speaker. Main steps are as follows:

Synthesis example: If it is intended to say “Follow all epidemic prevention measures during epidemic prevention” at a relatively slow speed by using a sound of a first speaker, the following steps need to be included:

Step S410: Obtain a to-be-synthesized audio file, that is, record a speech of a sentence in any language of a first speaker, for example, “It's a nice day today”.

Step S420: Perform analysis by using an acoustic processor, that is, convert the speech into a frequency spectrum or directly input the speech into the acoustic processor to extract features.

Step S430: Obtain acoustic parameters of the sound of the first speaker.

Step S450: Downgrade a speed item parameter, and keep other parameters unchanged.

Step S460: Convert a to-be-synthesized text into a phone form.

Step S470: Input the parameters in step S450 and phones in step S460 into a TTS synthesizer.

Step S480: Output a synthesized speech. It means to output a slogan saying (reading) “Follow all epidemic prevention measures during epidemic prevention” by using the speech of the first speaker.

In summary, the present invention has the following advantages:

1. By using a new speaker coding technology, universal speech feature vectors are obtained, and are used in a TTS model, so that the TTS model may adapt to an unknown speaker, and may even generate a speaker autonomously.

2. A cross-language output may be made between an original audio file and a generated speech.

3. Acoustic features may be quantified and a TTS model is controllable.

Although the present invention is disclosed above with the foregoing embodiments, the embodiments are not intended to limit the present invention, and equivalent replacements of changes and refinements made by any person skilled in the art without departing from the spirit and scope of the present invention still fall within the scope of patent protection of the present invention.

What is claimed is:

1. A text-to-speech (TTS) dubbing system, comprising:
a speech input unit, configured to obtain speech information;
an input unit, configured to obtain target text information and a parameter adjustment instruction; and
a processing unit, comprising:
an acoustic module, configured to obtain a speech feature vector and an acoustic parameter of the speech information; and
a text phoneme analysis module, configured to analyze a phoneme sequence corresponding to the target text information according to the target text information; and
an audio synthesis unit, configured to adjust the acoustic parameter of the speech information according to the parameter adjustment instruction, and combine speech information obtained after the acoustic parameter is adjusted with the target text information to form a synthesized audio.

2. The TTS dubbing system according to claim 1, wherein the acoustic module further comprises a speech feature acquisition module, a speech state analysis module, and a speech matching module.

3. The TTS dubbing system according to claim 2, wherein the speech feature acquisition module converts a speech feature corresponding to the speech information into the speech feature vector according to the speech information.

4. The TTS dubbing system according to claim 2, wherein the speech state analysis module is configured to obtain the acoustic parameter.

5. The TTS dubbing system according to claim 1, wherein the audio synthesis unit imports a neural network model, and trains the neural network model according to the speech feature vector and the acoustic parameter, to establish a TTS model.

6. The TTS dubbing system according to claim 5, wherein the audio synthesis unit inputs a target speech file of a speech database into the acoustic module, and obtains a target speech feature vector and a target acoustic parameter through forward propagation of the neural network model.

7. The TTS dubbing system according to claim 6, wherein the audio synthesis unit forward propagates a predicted target audio file according to the target speech feature vector and the target acoustic parameter.

8. The TTS dubbing system according to claim 7, wherein the processing unit calculates an error value between the predicted target audio file and the target speech file.

9. The TTS dubbing system according to claim 8, wherein the neural network model backpropagates the error value according to the error value, and adjusts the audio synthesis unit and the acoustic module according to the error value.

10. A text-to-speech (TTS) dubbing system, comprising:
a speech input unit, configured to obtain speech information;
an input unit, configured to obtain target text information and a parameter adjustment instruction; and
a processing unit, comprising:
an acoustic module, configured to obtain a speech feature vector and an acoustic parameter of the speech information; and
a text phoneme analysis module, configured to analyze a phoneme sequence corresponding to the target text information according to the target text information; and
an audio synthesis unit, configured to import the parameter adjustment instruction into a TTS model to adjust the acoustic parameter of the speech information, and combine speech information obtained after the acoustic parameter is adjusted with the target text information to form a synthesized audio.
